(19) United States
(12) Patent Application Publication
(10) Pub. No.: US 2017/0345379 A1
(43) Pub. Date: Nov. 30, 2017

(54) BACKLIGHT CONTROL METHODS OF LIQUID CRYSTAL DEVICES (LCDS), BACKLIGHT CONTROL DEVICES, AND LCDS

(71) Applicant: Wuhan China Star Optoelectronics Technology Co., Ltd., Wuhan (CN)

(72) Inventors: Xingling GUO, Shenzhen (CN); Xiaoping TAN, Shenzhen (CN); Jiehui QIN, Shenzhen (CN)

(73) Assignee: Wuhan China Star Optoelectronics Technology Co., Ltd., Wuhan (CN)

(21) Appl. No.: 15/224,455

(22) Filed: Jul. 29, 2016

(30) Foreign Application Priority Data
May 25, 2016 (CN) 201610353373.6

(51) Int. Cl. G09G 3/34; G09G 3/36

(52) U.S. Cl. CPC G09G 3/3406; G09G 3/36; G09G 2320/0646

(57) ABSTRACT

The present disclosure relates to a backlight control method of LCDs. The method includes dividing an effective display area of the LCD into a plurality of sub-display areas along a predetermined direction, obtaining an average brightness of display images of each of the sub-display areas, and adjusting a backlight brightness of the LCD in accordance with the average brightness of the display images of each of the sub-display areas. As such, the backlight brightness of the LCD within each of image display periods is compatible with the average brightness of the displayed images of each of the sub-display areas. The present disclosure also relates to a LCD and the backlight control method thereof. The effective display area of the LCD is divided into a plurality of display areas.

### BACKGROUND OF THE INVENTION

### 1. Field of the Invention

The present disclosure relates to liquid crystal display technology, and more particularly to a backlight control method of liquid crystal devices (LCDs), a backlight control device, and a LCD.

### 2. Discussion of the Related Art

With the development of Optoelectronics and semiconductor technologies, flat panel displays are greatly developed. Among the flat panel display, LCD is characterized by attributes such as high space efficiency, low power consumption, no radiation, and low electromagnetic interference, and has been adopted in various devices.

Currently, smart devices, such as cellular phones and tablets, may adopt LCD as display panel. Among the smart devices, the power consumption of the LCD may be in a range from 60% to 70% of the whole device. However, the power consumption of the backlight module may be in a range from 70% to 80%. Along with the thinner smart devices, the capacity of the internal battery gets smaller. Thus, how to reduce the power consumption of the smart devices is a very critical issue.

Content Adaptive Brightness Control (CABC) relates to one solution for reducing the power consumption of backlight via adjusting the brightness of the backlight. The method include detecting an average brightness of the displayed image, and adjusting the backlight brightness of the LCD in accordance with the detected average brightness. At the same time, the grayscale value of the displayed image is increased so as to compensate the reduced brightness.

However, with respect to the conventional CABC solution, the darker area within the image may lower down the average brightness of the whole image, and thus the backlight brightness may be adjusted to be a very low level. However, the grayscale value of the brightest area within the whole image, such as the saturated grayscale value (255), cannot be increased after being lowered down, which results in a darker display. Further, the display performance of the LCD may be affected.

### SUMMARY

To overcome the above problems, the present disclosure relates to a backlight control method of LCDs, a backlight control device, and a LCD.

In one aspect, a backlight control method of liquid crystal devices (LCDs) includes: dividing an effective display area of the LCD into a plurality of sub-display areas along a predetermined direction; obtaining an average brightness of display images of each of the sub-display areas; and adjusting a backlight brightness of the LCD in accordance with the average brightness of the display images of each of the sub-display areas, such that the backlight brightness of the LCD within each of image display periods is compatible with the average brightness of the displayed images of each of the sub-display areas.

Wherein the step of adjusting the backlight brightness of the LCD in accordance with the average brightness of the display images of each of the sub-display areas further includes: within the image display periods of each of the sub-display areas, generating adjustment signals and synchronous signals corresponding to the averaged brightness of the displayed images of each of the sub-display areas; adjusting the backlight brightness of the LCD in accordance with the adjustment signals and the synchronous signals such that within each of the image display periods, the backlight brightness of the LCD is compatible with the average brightness of each of the displayed images of the sub-display areas.

Wherein the adjustment signals are level signals.

Wherein the step of dividing the effective display area of the LCD into a plurality of sub-display areas along a predetermined direction further includes: dividing the effective display area of the LCD into a plurality of sub-display areas along a top-down direction.

In another aspect, a backlight control device of LCDs includes: a display area division module configured to divide an effective display area of the LCD into a plurality of sub-display areas along the predetermined direction; a brightness obtaining module configured to obtain an average brightness of displayed image of each of the sub-display areas; a backlight adjustment module configured to adjust a backlight brightness of the LCD in accordance with the average brightness of the display images of each of the sub-display areas, such that the backlight brightness of the LCD within each of the image display periods is compatible with the average brightness of the displayed images of each of the sub-display areas.

Wherein the backlight control module includes: a signal generator configured to generate corresponding adjustment signals and synchronous signals in accordance with the averaged brightness of the displayed image of the sub-display area within each of the image display periods of each of the sub-display areas; a backlight adjustor configured to adjust the backlight brightness of the LCD in accordance with the adjustment signals and the synchronous signals such that the backlight brightness of the LCD is compatible with the average brightness of the displayed images of each of the sub-display areas within each of the image display periods of each of the sub-display areas.

Wherein the adjustment signals are level signals.

Wherein the display area division module is configured to divide the effective display area of the LCD into a plurality of sub-display areas along a top-down direction.

In another aspect, a LCD includes the above backlight control device.

In another aspect, a LCD is disclosed, wherein a backlight of the LCD is adjusted by the above backlight control method.

The effective display area of the LCD is divided into a plurality of display areas. The backlight brightness of the LCD is adjusted within each of the image display periods of each of the sub-display areas, such that the backlight brightness of the LCD within each of image display periods is compatible with the average brightness of the displayed images of each of the sub-display areas. In this way, the display performance of the LCD may be enhanced.

### BRIEF DESCRIPTION OF THE DRAWINGS

FIG. 1 is a flowchart illustrating a backlight control method of LCDs in accordance with one embodiment.

FIG. 2 is a schematic view showing the division of the effective display area of the LCD in accordance with one embodiment.

FIG. 3 is a block diagram of the backlight control device of the LCD in accordance with one embodiment.

### DETAILED DESCRIPTION OF THE EMBODIMENTS

Embodiments of the invention will now be described more fully hereinafter with reference to the accompanying drawings, in which embodiments of the invention are shown.

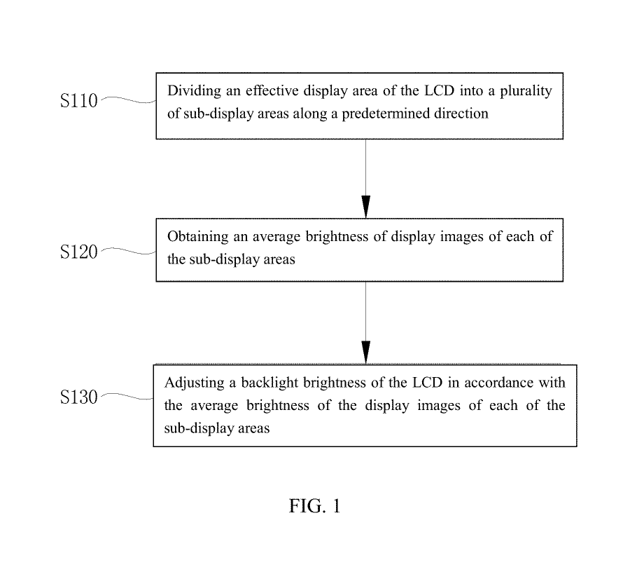

FIG. 1 is a flowchart illustrating a backlight control method of LCDs in accordance with one embodiment.

In step S110, an effective display area of the LCD is divided into a plurality of sub-display areas along a predetermined direction.

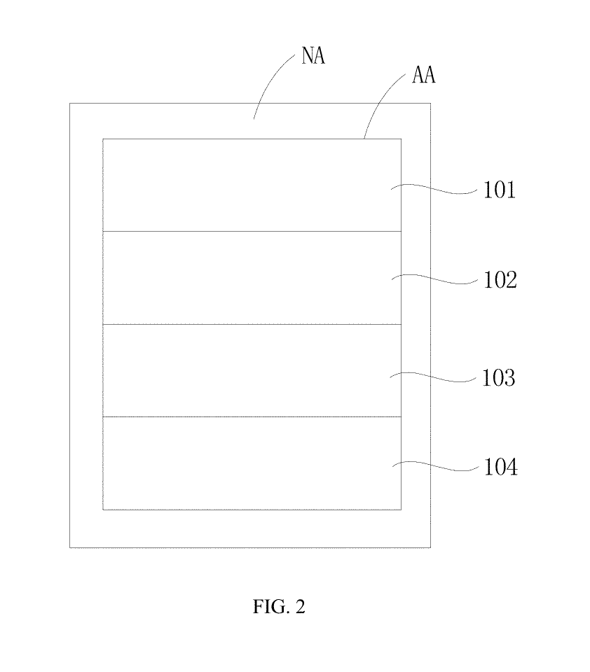

As shown in FIG. 2, the effective display area (AA) of the LCD is divided into four sub-display areas 101, 102, 103, and 104 along a top-down direction. In FIG. 2, an invalid display area (NA) surrounds the effective display area (AA). It is to be noted that the present disclosure is not limited to the above dividing method, and so does the number of the sub-display areas in FIG. 2. For instance, the effective display area (AA) of the LCD may be divided into four sub-display areas along a left-right direction. In another example, the effective display area (AA) of the LCD may be divided into two, three, or more sub-display areas along the top-down direction.

In step S120, obtaining an average brightness of display images of each of the sub-display areas.

A frame displaying time of the LCD for refreshing the displayed image is divided into four periods, that is, each of the periods is an image displaying period of one sub-display area.

The four image display periods are respectively defined as a first time period, a second time period, a third time period, and a fourth time period, wherein the first time period is configured for displaying the images of the sub-display area 101, the second time period is configured for displaying the images of the sub-display area 102, the third time period is configured for displaying the images of the sub-display area 103, and the fourth time period is configured for displaying the images of the sub-display area 104.

In step S130, adjusting a backlight brightness of the LCD, i.e., the backlight brightness of the backlight module of the LCD, in accordance with the detected average brightness of the display images of each of the sub-display areas, such that the backlight brightness of the LCD within each of the image display periods is compatible with the average brightness of the displayed images of each of the sub-display areas.

Specifically, the step of adjusting the backlight brightness of the LCD in accordance with the detected average brightness of the display images of each of the sub-display areas further includes: within the image display periods of each of the sub-display areas, generating adjustment signals and synchronous signals corresponding to the averaged brightness of the displayed images of each of the sub-display areas, and adjusting the backlight brightness of the LCD in accordance with the adjustment signals and the synchronous signals. As such, within each of the image display periods, the backlight brightness of the LCD is compatible with the average brightness of each of the displayed images of the sub-display areas.

In an example, when the sub-display area 101 displays the images, the adjustment signals and the synchronous signals corresponding to the displayed image of the sub-display area 101 are generated in accordance with the averaged brightness of the displayed image of the sub-display area 101. The backlight brightness of the LCD is adjusted by the adjustment signals and the synchronous signals corresponding to the displayed image of the sub-display area 101 such that the backlight brightness of the LCD is compatible with the average brightness of the displayed images of the sub-display area 101 when the sub-display area 101 displays the image.

When the sub-display area 102 displays the images, the adjustment signals and the synchronous signals corresponding to the displayed image of the sub-display area 102 are generated in accordance with the averaged brightness of the displayed image of the sub-display area 102. The backlight brightness of the LCD is adjusted by the adjustment signals and the synchronous signals corresponding to the displayed image of the sub-display area 102 such that the backlight brightness of the LCD is compatible with the average brightness of the displayed images of the sub-display area 102 when the sub-display area 102 displays the image.

When the sub-display area 103 displays the images, the adjustment signals and the synchronous signals corresponding to the displayed image of the sub-display area 103 are generated in accordance with the averaged brightness of the displayed image of the sub-display area 103. The backlight brightness of the LCD is adjusted by the adjustment signals and the synchronous signals corresponding to the displayed image of the sub-display area 103 such that the backlight brightness of the LCD is compatible with the average brightness of the displayed images of the sub-display area 103 when the sub-display area 103 displays the image.

When the sub-display area 104 displays the images, the adjustment signals and the synchronous signals corresponding to the displayed image of the sub-display area 104 are generated in accordance with the averaged brightness of the displayed image of the sub-display area 104. The backlight brightness of the LCD is adjusted by the adjustment signals and the synchronous signals corresponding to the displayed image of the sub-display area 104 such that the backlight brightness of the LCD is compatible with the average brightness of the displayed images of the sub-display area 104 when the sub-display area 104 displays the image.

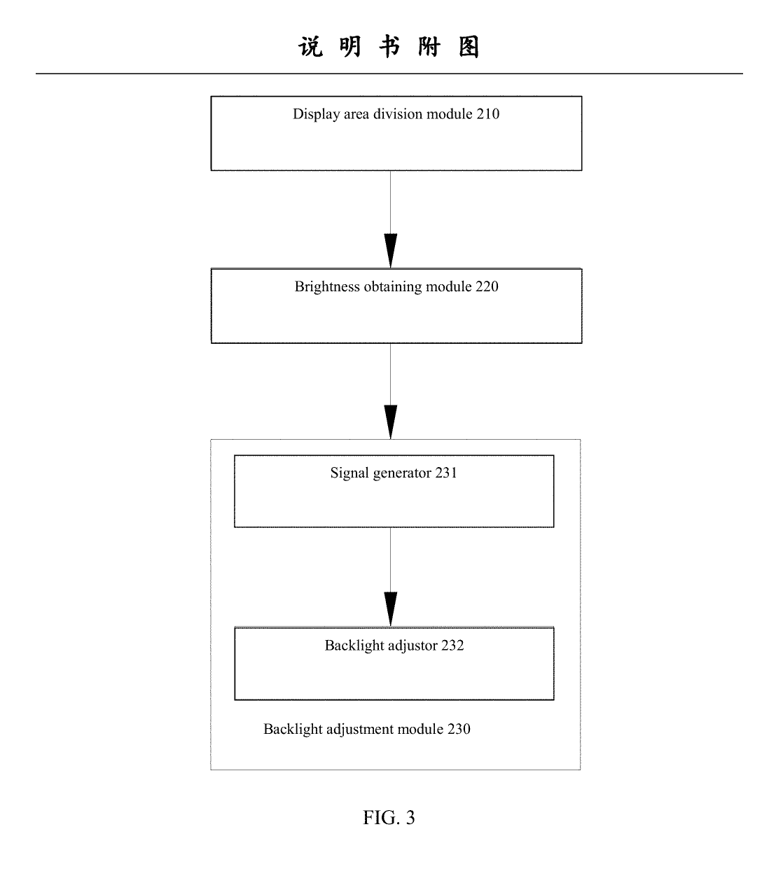

FIG. 3 is a block diagram of the backlight control device of the LCD in accordance with one embodiment.

Referring to FIG. 3, the backlight control device includes a display area division module 210, a brightness obtaining module 220, and a backlight adjustment module 230.

The display area division module 210 is configured to divide the effective display area of the LCD into a plurality of sub-display areas along the predetermined direction.

As shown in FIG. 2, the display area division module 210 divides the effective display area (AA) into four sub-display areas 101, 102, 103, and 104 along a top-down direction. In FIG. 2, an invalid display area (NA) surrounds the effective display area (AA). It is to be noted that the present disclosure is not limited to the above dividing method, and so does the number of the sub-display areas in FIG. 2. For instance, the effective display area (AA) of the LCD may be divided into four sub-display areas along a left-right direction. In another example, the effective display area (AA) of the LCD may be divided into two, three, or more sub-display areas along the top-down direction.

The brightness obtaining module 220 is configured to obtain the average brightness of the displayed image of each of the sub-display areas.

A frame displaying time of the LCD for refreshing the displayed image is divided into four periods, that is, each of the periods is an image displaying period of one sub-display area.

The four image display periods are respectively defined as a first time period, a second time period, a third time period, and a fourth time period, wherein the first time period is configured for displaying the images of the sub-display area 101, the second time period is configured for displaying the images of the sub-display area 102, the third time period is configured for displaying the images of the sub-display area 103, and the fourth time period is configured for displaying the images of the sub-display area 104.

The backlight adjustment module 230 is configured to adjust a backlight brightness of the LCD, i.e., the backlight brightness of the backlight module of the LCD, in accordance with the detected average brightness of the display images of each of the sub-display areas, such that the backlight brightness of the LCD within each of the image display periods is compatible with the average brightness of the displayed images of each of the sub-display areas.

Specifically, the backlight adjustment module 230 includes a signal generator 231 and a backlight adjustor 232.

Within each of the image displaying periods of each of the sub-display areas, the signal generator 231 generates corresponding adjustment signals and the synchronous signals in accordance with the averaged brightness of the displayed image of the sub-display area. The backlight adjustor 232 adjusts the backlight brightness of the LCD in accordance with the adjustment signals and the synchronous signals such that the backlight brightness of the LCD is compatible with the average brightness of the displayed images of each of the sub-display areas when the sub-display areas display the images.

In one example, when the sub-display area 101 displays the images, the adjustment signals and the synchronous signals corresponding to the displayed image of the sub-display area 101 are generated by the signal generator 231 in accordance with the averaged brightness of the displayed image of the sub-display area 101. The backlight brightness of the LCD is adjusted by the backlight adjustor 232 via the adjustment signals and the synchronous signals corresponding to the displayed image of the sub-display area 101 such that the backlight brightness of the LCD is compatible with the average brightness of the displayed images of the sub-display area 101 when the sub-display area 101 displays the image.

When the sub-display area 102 displays the images, the adjustment signals and the synchronous signals corresponding to the displayed image of the sub-display area 102 are generated by the signal generator 231 in accordance with the averaged brightness of the displayed image of the sub-display area 102. The backlight brightness of the LCD is adjusted by the backlight adjustor 232 via the adjustment signals and the synchronous signals corresponding to the displayed image of the sub-display area 102 such that the backlight brightness of the LCD is compatible with the average brightness of the displayed images of the sub-display area 102 when the sub-display area 102 displays the image.

When the sub-display area 103 displays the images, the adjustment signals and the synchronous signals corresponding to the displayed image of the sub-display area 103 are generated by the signal generator 231 in accordance with the averaged brightness of the displayed image of the sub-display area 103. The backlight brightness of the LCD is adjusted by the backlight adjustor 232 via the adjustment signals and the synchronous signals corresponding to the displayed image of the sub-display area 103 such that the backlight brightness of the LCD is compatible with the average brightness of the displayed images of the sub-display area 103 when the sub-display area 103 displays the image.

When the sub-display area 104 displays the images, the adjustment signals and the synchronous signals corresponding to the displayed image of the sub-display area 104 are generated by the signal generator 231 in accordance with the averaged brightness of the displayed image of the sub-display area 104. The backlight brightness of the LCD is adjusted by the backlight adjustor 232 via the adjustment signals and the synchronous signals corresponding to the displayed image of the sub-display area 104 such that the backlight brightness of the LCD is compatible with the average brightness of the displayed images of the sub-display area 104 when the sub-display area 104 displays the image.

In addition, the modules or the units within the backlight control device of the LCD may be implemented by hardware components. The functions or processes executed by the modules or the units may be realized by FPGA or ASIC by persons in ordinary skill.

Preferably, in the above embodiments, the adjustment signals are level signals, wherein the duty cycle ratio of the level signals corresponding to the images displayed by different sub-display areas are different. In this way, the level signals of different duty cycle ratios may be adopted to control the backlight brightness of the LCD, such that the backlight brightness of the LCD may be compatible with the displayed images of the sub-display areas.

In addition, in the above embodiments, the synchronous signals may guarantee that, within each of the frame displaying periods, the backlight brightness of the LCD may be controlled so as to be consistent with the displayed images of each of the sub-display areas.

In view of the above, the optical performance of the displayed image of the LCD may be enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight control method of liquid crystal devices (LCDs), comprising:
dividing an effective display area of the LCD into a plurality of sub-display areas along a predetermined direction;
obtaining an average brightness of display images of each of the sub-display areas; and
adjusting a backlight brightness of the LCD in accordance with the average brightness of the display images of each of the sub-display areas, such that the backlight brightness of the LCD within each of image display periods is compatible with the average brightness of the displayed images of each of the sub-display areas.

2. The backlight control method as claimed in claim 1, wherein the step of adjusting the backlight brightness of the LCD in accordance with the average brightness of the display images of each of the sub-display areas further comprises:
within the image display periods of each of the sub-display areas, generating adjustment signals and synchronous signals corresponding to the averaged brightness of the displayed images of each of the sub-display areas;
adjusting the backlight brightness of the LCD in accordance with the adjustment signals and the synchronous signals such that within each of the image display periods, the backlight brightness of the LCD is compatible with the average brightness of each of the displayed images of the sub-display areas.

3. The backlight control method as claimed in claim 2, wherein the adjustment signals are level signals.

4. The backlight control method as claimed in claim 1, wherein the step of dividing the effective display area of the LCD into a plurality of sub-display areas along a predetermined direction further comprises:
dividing the effective display area of the LCD into a plurality of sub-display areas along a top-down direction.

5. A backlight control device of LCDs, comprising:
a display area division module configured to divide an effective display area of the LCD into a plurality of sub-display areas along the predetermined direction;
a brightness obtaining module configured to obtain an average brightness of displayed image of each of the sub-display areas; and
a backlight adjustment module configured to adjust a backlight brightness of the LCD in accordance with the average brightness of the display images of each of the sub-display areas, such that the backlight brightness of the LCD within each of the image display periods is compatible with the average brightness of the displayed images of each of the sub-display areas.

6. The backlight control device as claimed in claim 5, wherein the backlight control module comprises:
a signal generator configured to generate corresponding adjustment signals and synchronous signals in accordance with the averaged brightness of the displayed image of the sub-display area within each of the image display periods of each of the sub-display areas;
a backlight adjustor configured to adjust the backlight brightness of the LCD in accordance with the adjustment signals and the synchronous signals such that the backlight brightness of the LCD is compatible with the average brightness of the displayed images of each of the sub-display areas within each of the image display periods of each of the sub-display areas.

7. The backlight control device as claimed in claim 6, wherein the adjustment signals are level signals.

8. The backlight control device as claimed in claim 5, wherein the display area division module is configured to divide the effective display area of the LCD into a plurality of sub-display areas along a top-down direction.

9. A LCD, wherein a backlight of the LCD is adjusted by backlight control method, the backlight control method comprising:
dividing an effective display area of the LCD into a plurality of sub-display areas along a predetermined direction;
obtaining an average brightness of display images of each of the sub-display areas; and
adjusting a backlight brightness of the LCD in accordance with the average brightness of the display images of each of the sub-display areas, such that the backlight brightness of the LCD within each of image display periods is compatible with the average brightness of the displayed images of each of the sub-display areas.
